(19) United States
(12) Patent Application Publication
(10) Pub. No.: US 2014/0338299 A1
(43) Pub. Date: Nov. 20, 2014

(54) MOUNTING OF STRING TRIMMER ON A GARDEN TRACTOR

(71) Applicant: Kenneth Lowery, Versailles, KY (US)

(72) Inventor: Kenneth Lowery, Versailles, KY (US)

(21) Appl. No.: 13/896,965

(22) Filed: May 17, 2013

(51) Int. Cl. A01D 34/416; A01D 34/00

(52) U.S. Cl. CPC A01D 34/4165; A01D 34/001
USPC 56/12.7

(57) ABSTRACT

A mounting arrangement for mounting a string trimmer to a host vehicle such as a ride-on mower or garden tractor. Functions provided by the mounting arrangement may include adjustment of height and inclination of the cutting head, and relocating the cutting head relative to the body of the host vehicle. The mounting arrangement may include a bumper for protecting the cutting head, cushioning of the mounting arrangement by springs to protect the cutting head from collisions, and transfer of liquid fuel from the fuel tank of the host vehicle to that of the string trimmer.

### CROSS REFERENCE TO RELATED APPLICATION

This application claims the benefit of the filing date under 35 USC 119(e) of the filing date of U.S. Provisional Application Ser. No. 61/810,003, filed Apr. 9, 2013, the contents of which are incorporated herein.

### FIELD OF THE INVENTION

The present invention relates to vehicles such as so-called garden tractors, ride-on mowers, and the like, and more particularly, to mounting a string trimmer on such a vehicle to increase cutting capabilities of the vehicle.

### BACKGROUND OF THE INVENTION

Many owners of large lawns, such as large residential estates and plots, farms, and other facilities having large lawns are presented with a problem in keeping the lawns tidy and neatly trimmed. Powered trimmers having rotatable filaments, which will be called string trimmers hereinafter, have been provided to reduce the labor burden of maintaining lawns and grounds neatly trimmed. However, hand held string trimmers must be lugged about by maintenance personnel on foot. This adds to the time and effort, and assures that large grounds will become expensive to maintain.

Small motorized lawn mowers capable of carrying a rider, which will be called ride-on mowers, and so-called garden tractors have been provided to enable a person to cover a considerably greater expanse of lawn than could be covered using a pushed mower, or even a self-powered mower wherein the user walks behind the mower. It is known to mount string trimmers to ride-on mowers and garden tractors.

However, there exists room in the art for improved string trimmer mountings which enable enhanced control over the cutting position of the string trimmer, so that most if not all cutting situations may be addressed by adjusting cutting from the operator's seat of the ride-on mower or garden tractor.

### SUMMARY OF THE INVENTION

The present invention addresses the above stated need by providing apparatus for mounting a conventional gasoline powered string trimmer to a host vehicle such as a ride-on mower or garden tractor which enables many adjustments to cutting by a person riding on the ride-on mower from the operator's seat. In particular, any of several positional adjustments may be made to the cutting position of the rotatable filament of the mounted string trimmer such that most cutting situations may be accommodated without requiring the operator to dismount from the operator's seat. These adjustments may include height of the filament, inclination of the plane occupied by the filament when rotating, and location of the cutting head of the string trimmer relative to the ride-on mower or garden tractor. The location may be varied either by changing the azimuthal orientation of the boom holding the cutting head, or by repositioning the entire string trimmer on the ride-on mower or garden tractor.

Moreover, many of these adjustments may be powered, so that the operator is afforded finger control thereof.

Other features of the novel mounting may include accommodation of collision of the cutting head of the string trimmer with relatively immovable environmental objects and powered transfer of fuel from the relatively large fuel tank of the ride-on mower or garden tractor to the relatively small fuel tank of the string trimmer.

It is an object of the invention to enable mounting of a conventional string trimmer to a ride-on mower and to a garden tractor.

Another object of the invention is to facilitate adjustment of cutting height, inclination of the plane of the cutting filament, and location of the cutting head relative to the host vehicle.

A further object of the invention is to accommodate collisions with environmental objects.

Still another object is to enable transfer of fuel from the fuel tank of the host vehicle to the fuel tank of gasoline powered string trimmers.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a vehicle having a string trimmer mounted thereto according to at least one aspect of the invention.

FIG. 2 is a diagrammatic detail view illustrating adjustability of part of the novel mounting relative to the vehicle.

FIG. 3 is a diagrammatic top plan detail view illustrating adjustability of the azimuth of a boom supporting the string trimmer.

FIG. 4 is a diagrammatic side detail view illustrating adjustability of raising and lowering the boom seen in FIG. 3.

FIG. 5 is a diagrammatic side detail view showing adjustability of the cutting head of the string trimmer relative to the boom seen in FIG. 3.

FIG. 6 is a diagrammatic representation of components for adjusting the azimuth of the boom.

FIG. 7 is a diagrammatic representation of components for elevating and lowering the boom.

FIG. 8 is a diagrammatic representation of components for adjusting tilt of the cutting head of the string trimmer.

FIG. 9 is a diagrammatic representation of a conventional small scale consumer ride-on mower which may be adapted to the purposes of the present invention.

FIG. 10 is a diagrammatic representation of a fuel transfer feature.

### DETAILED DESCRIPTION

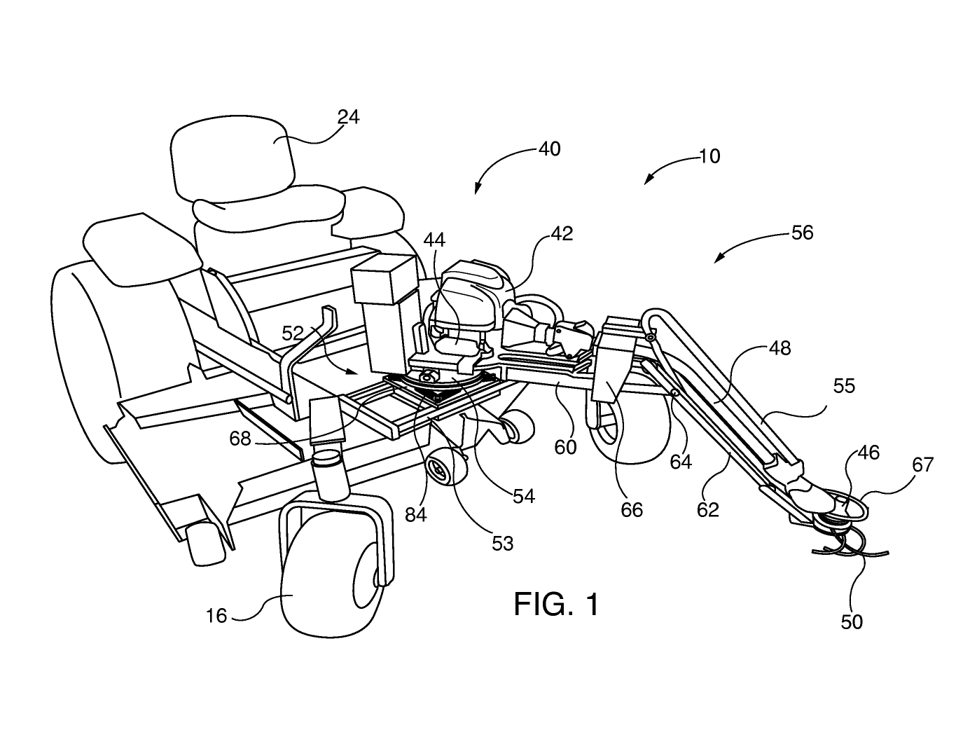

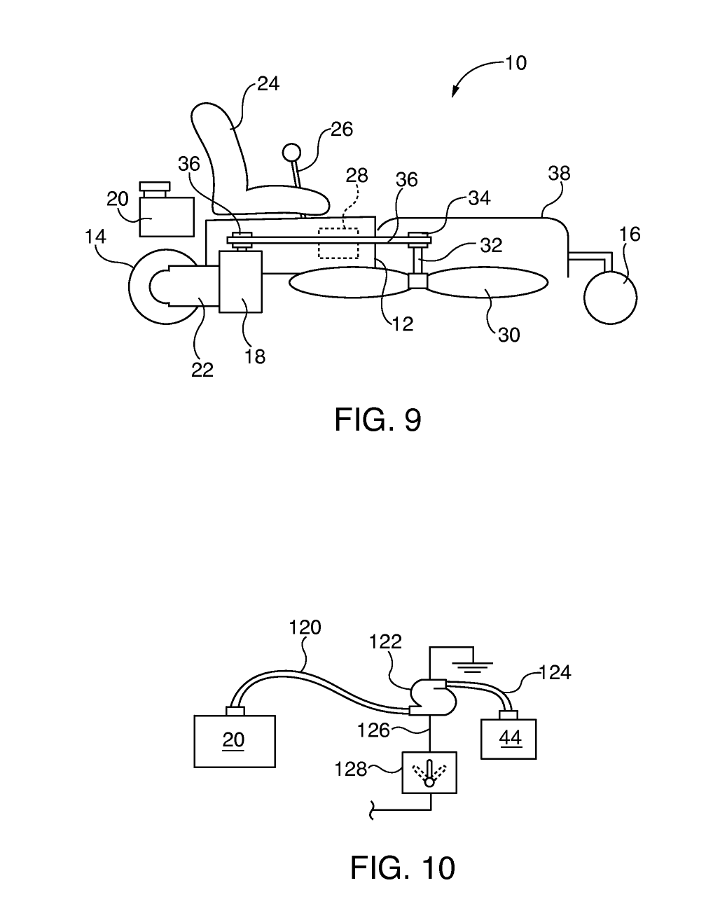

Referring first to FIG. 1, according to at least one aspect of the invention, there is shown a host vehicle 10 adapted to include a mounting arrangement for mounting to the host vehicle 10 a string trimmer 40. The host vehicle 10 may be an otherwise conventional vehicle such as those known as ride-on mowers and garden tractor. Of course, the host vehicle 10, although depicted herein as a ride-on mower, may be still another type of vehicle, such as a boat adapted to trim plants from encroachment of a waterway, or still another vehicle. Regardless of its specific type, the host vehicle 10, shown in greater detail in FIG. 9, will be understood to comprise a frame 12 and road wheels 14, 16 coupled to the frame 12, an engine 18, a fuel tank 20 disposed to store fuel and supply stored fuel to the engine 18, a power train 22 disposed to transmit power from the engine 18 to at least one of the road wheels (such as the wheel 14), an operator's seat 24 and the usual controls (shown representatively as a lever 26, but which could include switches and other devices) provided to commercial consumer vehicles for enabling a person to operate the host vehicle 10 from the operator's seat 24. As depicted, the host vehicle 10 is a ride-on mower, which could be of the type known as a zero-turn mower, having a battery 28, a rotatable blade 30 driven by a shaft 32 bearing a pulley 34. The pulley 34 may be engaged by a drive belt 36 which in turn is rotated by an engine pulley 36 powered by the engine 18. Components comprising moving parts such as the blade 30 and the drive belt 36 are ordinarily covered by a body panel such as the deck 38. Additional body panels (not shown) may be provided. As these components may be conventional in that the host vehicle 10 may be a commercially available vehicle sold to the general public, the host vehicle 10 will be understood to include additional structure, circuitry, connections and supports, and other apparatus required for successful operation even if not specifically shown in detail.

The string trimmer 40 which is operable from the host vehicle 10 may be a commercially available product sold to the general public for trimming lawns. The string trimmer 40 may comprise a gasoline or other internal combustion engine 42, referred to herein as a gasoline engine only for semantic convenience, a fuel tank 44, a cutting head 46 supported from an elongated shaft 48, and a rotatable filament 50 which projects from the cutting head 46. Of course, the string trimmer may operate in conventional fashion, with the filament rotating rapidly under power from the gasoline engine. Novelty of the present invention lies in adapting the string trimmer 40 to the host vehicle 10 in a manner enabling versatile orientation of the string trimmer 40 relative to the host vehicle 10 and control of the string trimmer 40 from the operator's seat 24 of the host vehicle 10, rather than in either the host vehicle 10 or in the string trimmer 40 per se. It will be appreciated that elements of the novel mounting could be fabricated as part of either or both of the host vehicle 10 and the string trimmer 40, in which case the host vehicle 10 and the string trimmer 40 would no longer be regarded entirely as conventional, and would instead fall under the scope of the invention.

To this end, and referring specifically to FIG. 1, there is provided a mounting disposed to mount the string trimmer 40 to the host vehicle 10. The mounting may comprise a base 52 enabling engagement of the host vehicle 10 and coupling of the mounting arrangement to the host vehicle 10 by conventional manually installed fasteners (not specifically shown, but which could comprise bolts, rivets, pins which receive clips, and other known fasteners). Enablement of engagement signifies that the base 52 may be dimensioned and configured to cooperate with a suitable sturdy portion of the host vehicle 10, such as the deck 38, where the deck 38 is deemed sufficiently sturdy to withstand static and dynamic loads imposed by the string trimmer 40 and the mounting. In most cases, mower decks such as the deck 38 are indeed suitable to support the mounting.

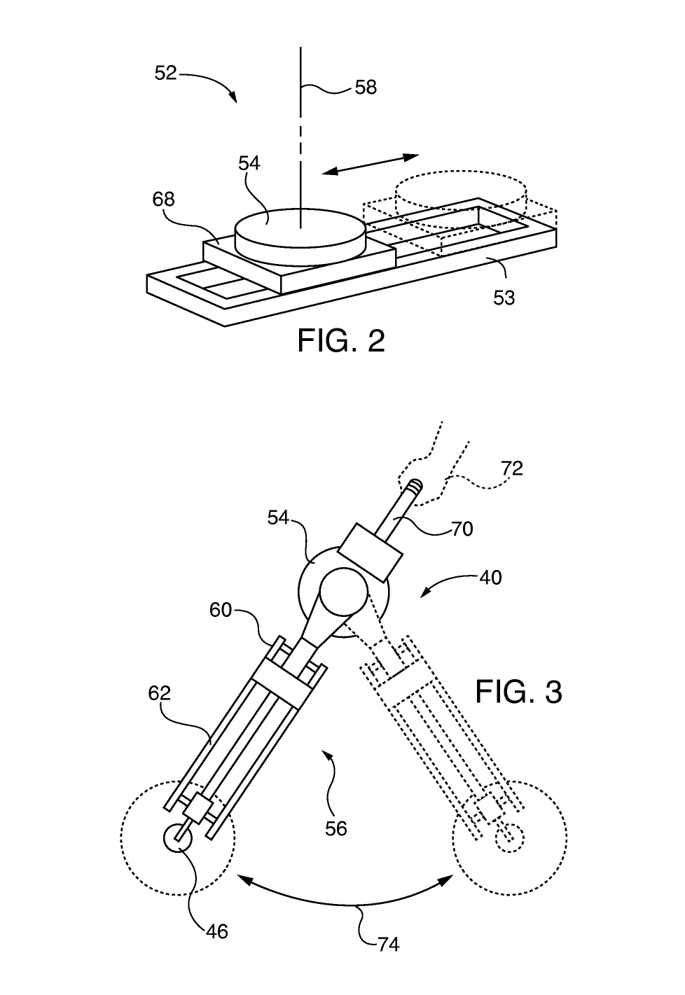

As depicted the base 52comprises tracks 53 which partially engage and guide elements such as feet (not shown) of a turntable 54 such that the turntable 54 may translate along the tracks 53 so as to be repositioned in a horizontal direction relative to the host vehicle 10. The base 52 may be immovably fixed to the host vehicle 10 by the fasteners. By contrast, the turntable 54, which in turn serves as a base for mounting a boom 56, is rotatable relative to the base 52 about a vertical axis 58 (seen in FIG. 2). With the boom 56 mounted to the turntable 54, rotation of the turntable 54 adjusts azimuth of the boom 56 relative to the host vehicle 10.

The turntable 54 may be disposed to be generally horizontal when mounted to the base 52. It should be noted at this point that orientational terms such as left and right refer to the subject drawing as viewed by an observer. The drawing figures depict their subject matter in orientations of normal use, which could obviously change with changes in vehicle orientation on the supporting ground or other supporting environmental surface. Therefore, orientational terms must be understood to provide semantic basis for purposes of description, and do not limit the invention or its component parts in any particular way. It would be possible to mount a string trimmer in orientations other than that depicted herein.

The string trimmer 40 is removably mounted to the boom 56 in generally longitudinal alignment therewith. The boom 56 may be articulated, in that it comprises a proximal section, seen representatively as an arm 60 proximate the turntable 54, a distal section seen as an arm 62 located towards the distal end of the boom 56, and a tilt control arm 55. The arms 60 and 62 may be joined by a pivot joint 64. The proximal section and the distal section have longitudinal axes (not called out by reference numeral) which may be varied relative to their mutual alignment, this being accommodated by the pivot joint 64. Adjusting this alignment varies an included angle defined by the arms 60 and 62, which in turn varies the distance from the cutting head 46 to the turntable 54. The boom 56 is of dimensions that enable it to project beyond the host vehicle 10. Variation of alignment of the arms 60 and 62 may vary spacing of the cutting head 46 from the host vehicle 10. This may be advantageous in reaching vegetation to be trimmed.

This type of adjustment is desirable because the string trimmer 10 is secured to the boom 56 in a relatively fixed operable position. That is, engagement elements for securing the string trimmer 10 in place on the boom 56 necessarily restrict mobility of the string trimmer 10. This is necessary for secure connection of the string trimmer 10. Engagement elements, shown representatively by a bracket 66, may include straps, cushions, and other flexible, repositionable, and form accommodating apparatus to enable different models of string trimmers such as the string trimmer 10 to be employed while still being firmly secured to the boom 56.

A guard or bumper 67 which is disposed to at least partially encircle the cutting head 46 of the string trimmer 40 when the string trimmer 40 is in the operable position may be provided. The bumper 67 may take the form of a U-shaped rod which is spaced apart from the cutting head 46 and obstructs the cutting head 46 from direct contact with environmental objects (not shown) approaching the cutting head 46 in a horizontal direction.

Turning now to FIG. 2, it is seen that the one adjustment to position of the string trimmer 10 may be location of the turntable 54 along the tracks 53. The base 52 may include a rigid platform 68 which is adapted to ride along the tracks 53 and to which the turntable 54 is coupled for rotation about the axis 58. This adjustment may be manual, with securement of the platform 68 in a selected position by a clamp such as a thumbscrew (not shown), or may be motorized if desired.

Connection of the rigid platform 68 to the turntable 54 may incorporate a plurality of coil springs 84 coupled to the turntable 54 and to the rigid platform 68 of the base 52 in a manner which absorb recoil when the boom 56 encounters a relatively immovable environmental object (not shown) while the host vehicle 10 is moving.

FIG. 3 illustrates adjustment of the azimuth of the boom 56, and also shows one option for manually making this adjustment. A handle lever 70 which is graspable by the hand 72 of the operator may be provided if a motorized adjustment feature is not provided. An arrow 74 indicates an exemplary degree of azimuthal adjustment.

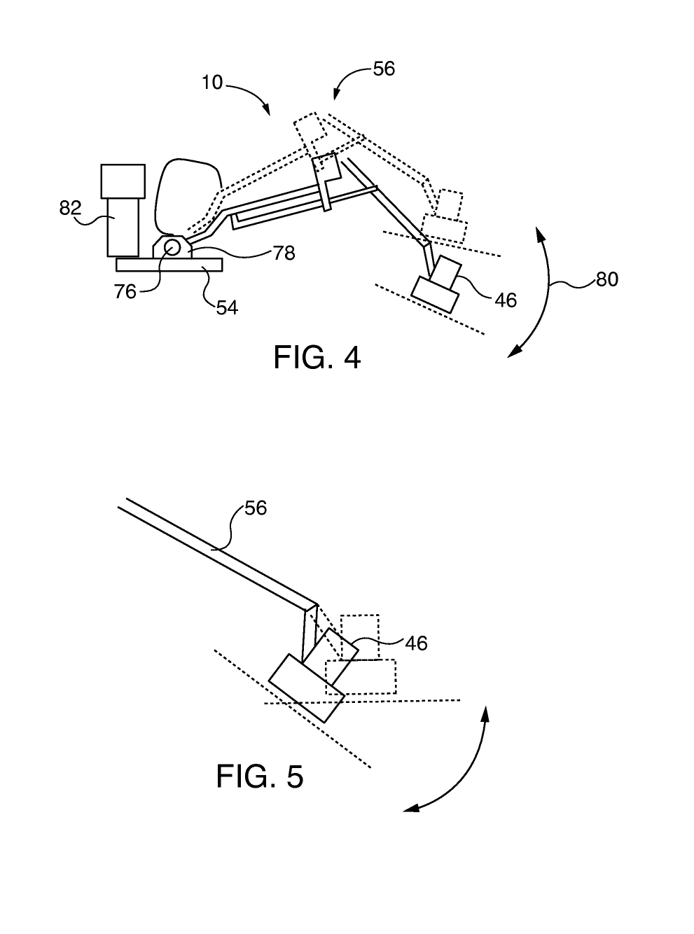

FIG. 4 shows details of a boom pivot mechanism disposed to increase and decrease inclination of the boom 56 relative to the turntable 54 and therefore to the host vehicle 10 (not seen in FIG. 4). The boom 56 may be anchored to the turntable 54 at a pivot joint comprising an axle 76 and a trunnion 78 supporting the axle 76. The boom 56 may be raised and lowered such that its distal end moves as indicated by the arrow 80. This motion may be effected by for example a gearmotor (further shown and described with reference to FIG. 7), which may be housed in a control enclosure 82 or otherwise disposed. As a non-limiting example, the term “gearmotor” may include devices such as actuators.

Referring to FIG. 5, the mounting arrangement may comprise an altitude adjuster disposed to vary inclination of the cutting head 46 relative to the boom 56 under control of a person from the operator's seat 24. The altitude adjuster may comprise a parallelogram type control linkage mounted to the boom 56. This is further described with reference to FIG. 8.

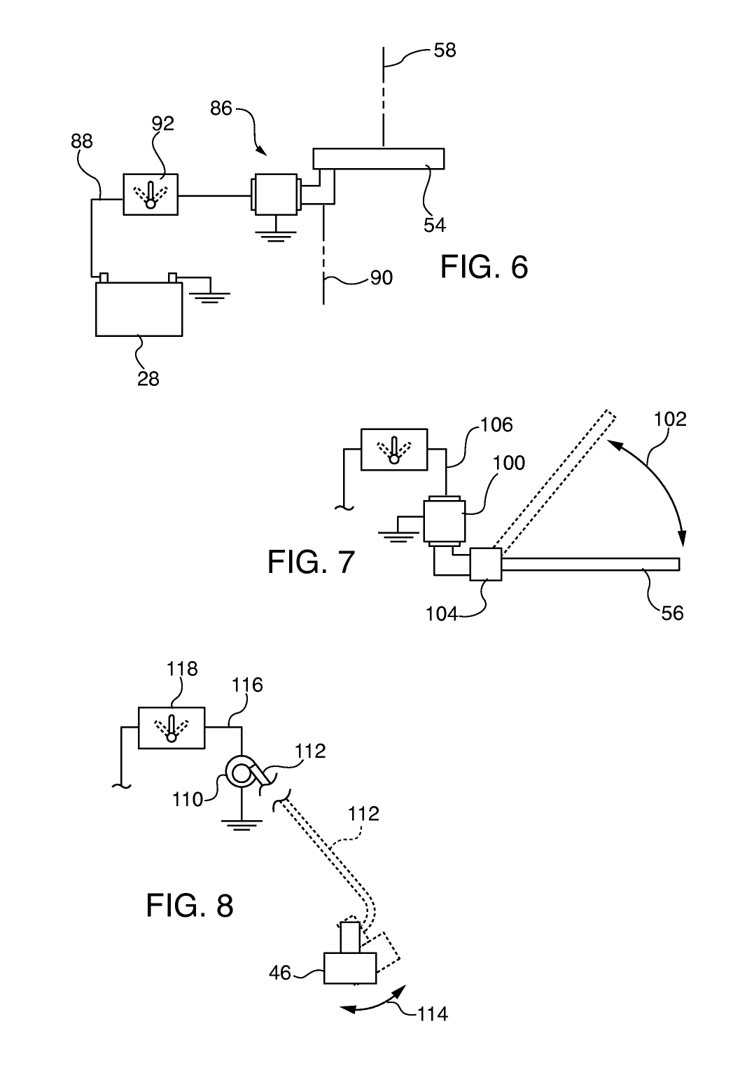

In FIG. 8, it is seen that an altitude adjuster motor 110 may engage a linkage rod 112 to pull and push on the cutting head 46. The cutting head 46 may be pivotally coupled to the boom 56 so that motion of the linkage rod 112 effects arcuate movement of the cutting head 46, as indicated by the arrow 114. The altitude adjuster motor 110 may be provided with an electrical power and control circuit 116 incorporating a three position switch 118. Control positions of the three position switch 118 may include illustratively an arbitrarily designated elevating or up direction, an arbitrarily designated lowering or down direction, and a neutral position in which the cutting head 46 does not move. The circuit 116 may be connected to the battery 28 of the host vehicle 10 and suitably connected to ground as shown with the circuit 88 in FIG. 6.

Turning now to FIG. 6, the mounting arrangement may comprise an azimuthal control gearmotor 86 disposed to rotate the turntable 54 relative to the rigid platform 68 of the base 50 (the rigid platform 68 is omitted from FIG. 6). The axis of rotation 90 of the azimuthal control gearmotor 86 is indicated in FIG. 6, and may engage a suitable toothed rack (not shown) or other apparatus of the turntable 54 to effect rotation of the latter. An electrical circuit 88 may enable the azimuthal control gearmotor 86 to be operated by a person from the operator's seat 24. The circuit 88 may include a switch such as a three position switch 92 for controlling the azimuthal control gearmotor 86. Control positions may include illustratively an arbitrarily designated forward direction, an arbitrarily designated reverse direction, and a neutral position in which the turntable 54 is not rotated. The circuit 88 may be connected to the battery 28 of the host vehicle 10 and suitably connected to ground as shown for operability.

FIG. 7 shows a boom inclination gearmotor 100 disposed to raise and lower the boom 56 in a vertical plane (seen as an arcuate path indicated by the arrow 102). The boom inclination gearmotor 100 may engage a suitable gearset 104 fixed for example to the axle 76 supported on the trunnion 78 (seen in FIG. 4). The boom inclination gearmotor 100 may be controlled by an electrical circuit 106 enabling the boom inclination gearmotor 100 to be operated by a person from the operator's seat 24. The electrical circuit 106 may include a three position switch 108 adapted to connect power to raise and lower the boom 16, and to maintain the boom 16 in a selected position by de- energizing the boom inclination gearmotor 100.

FIG. 10 shows a fuel transfer arrangement disposed to transfer liquid fuel from the fuel tank 20 of the host vehicle 10 to the fuel tank 44 of the string trimmer 40. A hose 120 may be connected to the suction side of a pump 122, which will be understood to incorporate an electric motor. The hose 120 communicates with the fuel tank 20. The outlet side of the pump 122 may be connected to a hose 124, which in turn is arranged to discharge into the fuel tank 44. The pump 122 may be provided with electrical power and controlled by an electrical circuit 126. The electrical circuit 126 may incorporate a two position switch 128 having a run position which would cause the pump 122 to operate and to cause fuel to flow from the fuel tank 20 to the fuel tank 44, and an off position in which the pump 122 does not operate. The electrical circuit 126 may be connected to the battery 28 of the host vehicle 10 and suitably connected to ground as shown in FIG. 6.

The invention may be regarded as a mounting arrangement for mounting a string trimmer such as the string trimmer 40 to a host vehicle such as the host vehicle 10. According to this aspect, the invention could take the form of a kit for providing necessary components, requiring additionally a conventional host vehicle and a conventional string trimmer The invention may also be thought of as a host vehicle improved by such a mounting arrangement, with or without a string trimmer operably installed thereto.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A mounting arrangement for mounting a string trimmer having a gasoline engine, a fuel tank, a cutting head and a rotatable filament projecting from the cutting head to a host vehicle having an engine, a fuel tank, and an operator's seat, while enabling use of the string trimmer from the host vehicle, comprising:
a base enabling engagement of the host vehicle and coupling of the mounting arrangement to the host vehicle by conventional manually installed fasteners;
a turntable which is disposed to be generally horizontal when mounted to the base, and which enables rotation about a vertical axis;
a boom mounted to the turntable so as to project beyond the host vehicle, and comprising engagement elements for removably securing the string trimmer to the boom in an operable position;
a boom pivot mechanism disposed to increase and decrease inclination of the boom relative to the host vehicle; and
an altitude adjuster disposed to vary inclination of the cutting head relative to the boom under control of a person from the operator's seat.

2. The mounting arrangement of claim 1, wherein the base comprises a track and the turntable comprises engagement elements enabling the turntable to be translated along the track, whereby the turntable may be repositioned in a horizontal direction relative to the host vehicle.

3. The mounting arrangement of claim 1, wherein the boom comprises a proximal section having a longitudinal axis, a distal section having a longitudinal axis, and a pivot joint enabling the longitudinal axis of the proximal section to be varied relative to its alignment with the longitudinal axis of the distal section.

4. The mounting arrangement of claim 1, wherein the altitude adjuster comprises a parallelogram type control linkage mounted to the boom.

5. The mounting arrangement of claim 1, further comprising a plurality of coil springs coupled to the turntable and to the base in a manner which absorb recoil when the boom encounters a relatively immovable environmental object while the host vehicle is moving.

6. The mounting arrangement of claim 1, further comprising an azimuthal control gearmotor disposed to rotate the turntable relative to the base, and an electrical circuit enabling the azimuthal control gearmotor to be operated by a person from the operator's seat.

7. The mounting arrangement of claim 1, further comprising a boom inclination gearmotor disposed to raise and lower the boom in a vertical plane, and an electrical circuit enabling the boom inclination gearmotor to be operated by a person from the operator's seat.

8. The mounting arrangement of claim 1, wherein the altitude adjuster comprises an electric motor and electrical circuitry disposed to control the altitude adjuster.

9. The mounting arrangement of claim 1, further comprising a bumper disposed to at least partially encircle the cutting head of the string trimmer when the string trimmer is in the operable position and to obstruct the cutting head from direct contact with environmental objects approaching the cutting head in a horizontal direction.

10. The mounting arrangement of claim 1, further comprising a fuel transfer arrangement disposed to transfer liquid fuel from the tank of the host vehicle to the fuel tank of the string trimmer

11. A host vehicle having a mounting arrangement for mounting to the host vehicle a string trimmer having a gasoline engine, a fuel tank, a cutting head and a rotatable filament projecting from the cutting head, comprising:
a frame and road wheels coupled to the frame;
an engine, a fuel tank disposed to store fuel and supply stored fuel to the engine, and a power train disposed to transmit power from the engine to the road wheels;
an operator's seat and controls for enabling a person to operate the host vehicle from the operator's seat;
a string trimmer which is operable from the host vehicle; and
a mounting disposed to mount the string trimmer to the host vehicle, comprising:
a base enabling engagement of the host vehicle and coupling of the mounting arrangement to the host vehicle by conventional manually installed fasteners;
a turntable which is disposed to be generally horizontal when mounted to the base, and which enables rotation about a vertical axis;
a boom mounted to the turntable so as to project beyond the host vehicle, and comprising engagement elements for removably securing the string trimmer to the boom in an operable position;
a boom pivot mechanism disposed to increase and decrease inclination of the boom relative to the host vehicle; and
an altitude adjuster disposed to vary inclination of the cutting head relative to the boom under control of a person from the operator's seat.

12. The host vehicle of claim 11, wherein the base comprises a track and the turntable comprises engagement elements enabling the turntable to be translated along the track, whereby the turntable may be repositioned in a horizontal direction relative to the host vehicle.

13. The host vehicle of claim 11, wherein the boom comprises a proximal section having a longitudinal axis, a distal section having a longitudinal axis, and a pivot joint enabling the longitudinal axis of the proximal section to be varied relative to its alignment with the longitudinal axis of the distal section.

14. The host vehicle of claim 11, wherein the altitude adjuster comprises a parallelogram type control linkage mounted to the boom.

15. The host vehicle of claim 11, further comprising a plurality of coil springs coupled to the turntable and to the base in a manner which absorb recoil when the boom encounters a relatively immovable environmental object while the host vehicle is moving.

16. The host vehicle of claim 11, further comprising an azimuthal control gearmotor disposed to rotate the turntable relative to the base, and an electrical circuit enabling the azimuthal control gearmotor to be operated by a person from the operator's seat.

17. The host vehicle of claim 11, further comprising a boom inclination gearmotor disposed to raise and lower the boom in a vertical plane, and an electrical circuit enabling the boom inclination gearmotor to be operated by a person from the operator's seat.

18. The host vehicle of claim 11, wherein the altitude adjuster comprises an electric motor and electrical circuitry disposed to control the altitude adjuster.

19. The host vehicle of claim 11, further comprising a bumper disposed to at least partially encircle the cutting head of the string trimmer when the string trimmer is in the operable position and to obstruct the cutting head from direct contact with environmental objects approaching the cutting head in a horizontal direction.

20. The host vehicle of claim 11, further comprising a fuel transfer arrangement disposed to transfer liquid fuel from the tank of engine of the host vehicle to the fuel tank of the string trimmer
